(19) United States
(12) Patent Application Publication
(10) Pub. No.: US 2004/0129536 A1
(43) Pub. Date: Jul. 8, 2004

(54) Bar screen module of a vibratory feeder

(76) Inventor: Reijo K Kankaanpaa, Tampere (FI)

Correspondence Address: Oliff & Berridge, PO Box 19928, Alexandria, VA, 22320, US

(21) Appl. No.: 10/475,803

(22) PCT Filed: May 17, 2002
(86) PCT No.: PCT/FI02/00422

(30) Foreign Application Priority Data
Jun. 6, 2001 (FI) 20011196

(51) Int. Cl. B65G 25/04

(52) U.S. Cl. 198/750.2

(57) ABSTRACT

This invention relates to a bar screen module of a vibratory feeder, comprising screen bars (1) extending in moving direction of a material, and screen apertures (2) arranged between the bar screens to enlarge wedge-shapedly in the moving direction of the material. The invention is characterized in that the upper part of each screen bar (1) is divided in the moving direction of the material into at least two parts (1a,1b) extending on different levels, whereby all upper surface parts (1a and 1b, respectively) of each level of the bar screen module form a stair step extending on the level in question transversely to the moving direction of the material.

The present invention relates to a bar screen module of a vibratory feeder, comprising screen bars extending in moving direction of the material, as well as screen apertures arranged between said screen bars to enlarge wedge-shapedly in the moving direction of the material.

Vibratory feeders are used in applications in which a batch process is to be converted to a continuous process. In crushing plants, a vibratory feeder is used i.e. to feed material to a crusher. In addition, the vibratory feeder can be used in a crushing or screening process when a material is fed onto a screen or a conveyor. The vibratory feeder consists of a basket and a vibratory machinery, and often also of one or several bar screen modules. If a feeder is provided with several bar screen modules, these are generally stagged in relation to each other to improve classification of the material.

By means of a bar screen module, a charge can be divided into two parts. The size of the screen apertures defines the separation limit. The material passing through the screen apertures is called undersize of the bar screen, and material pieces, such as stones, having a size larger than the screen aperture, are called oversize of the bar screen. On the basis of the screen aperture, for instance a large-grained material which is to be fed further to a next step for the treatment, can be separated from the feed. The undersize, i.e. the small-grained material, is generally classed as a so-called waste material, although also this material, depending on the quality requirements of various products, can in some cases be used as a finished end product.

In conventional bar screen modules, the screen bars and the apertures between them extend on one level wedge-shapedly from the entering end of the screen bar to its top end. This results in the fact that the screen aperture, due to its wedge-shape, is relatively narrow at its entering end, and therefore the fine-grained material to be removed from the charge, passes through the bar screen only at the end of the screen aperture, which declines the screening capacity and the accuracy of the separation.

An object of the present invention is to overcome the afore-mentioned disadvantages which object is obtainable by a bar screen module, which is characterized in that the upper part of each screen bar is divided in the moving direction of the material into at least two parts extending on different levels, whereby all upper surface parts on each level of the bar screen module form a stair step extending on the level in question transversely to the moving direction of the material. Because of the structure of this kind, the wedge-shaped screen apertures according to the invention are at their entering ends larger than the conventional screen apertures, while at the top end of each stair level, each screen aperture has a maximal size. Consequently, the bar screen module according to the invention has a larger free surface area, due to which the charge to be fed can be divided more efficiently into an overgrained and undergrained material size group. At each stair, the material to be fed is sorted once more when it falls onto the next level, due to which the accuracy of the separation is further improved. A comparison of a bar screen module according to the invention with a conventional bar screen module, having the same outer dimensions, shows that the bar screen module according to the invention has a considerably improved separating capacity and accuracy.

Further advantages of the invention are disclosed in the enclosed dependent claims 2 to 8.

In the following the invention will be described in more detail with reference to the accompying drawings in which

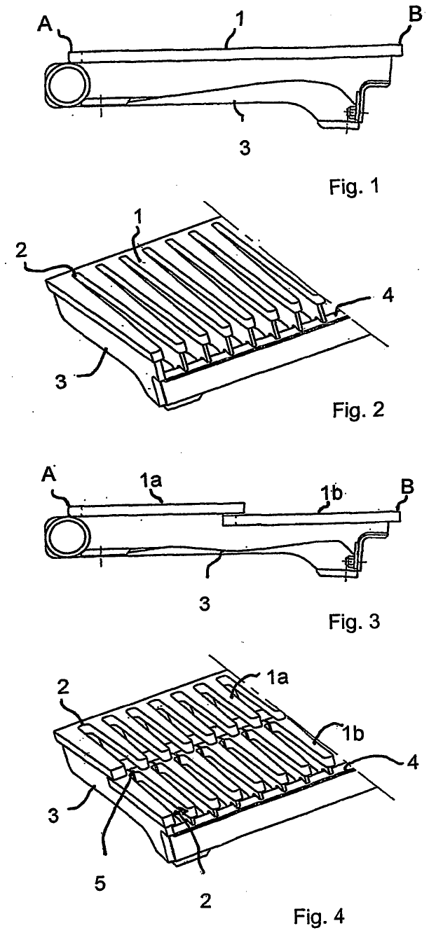

FIG. 1 shows a side view of a prior art screen bar,

FIG. 2 shows a perspective view of a bar screen module comprising screen bars according to FIG. 1,

FIG. 3 shows as an example a side view of a screen bar according to the invention and

FIG. 4 shows a perspective view of a bar screen module comprising screen bars according to FIG. 3.

The bar screen module according to the prior art comprises several screen bars 1, extending on same level from the entering end A of the bar screen module to its discharge end B, between which screen apertures 2 are arranged to enlarge wedge-shapedly in the moving direction of the material (FIGS. 1 and 2). In the shown embodiment, the bottom part of the screen bar 1 consists of a longitudinally extending web plate 3. Consequently, also said screen apertures 2 extend on same level from the entering end A of the bar screen module to its discharge end B. In order to prevent the screen aperture 1 from plugging, the screen aperture 2 has to be slightly wedge-shapedly enlarging in the moving direction of the material. Due to this fact, the screen apertures 2 of a conventional bar screen module are relatively small at the entering end A of the bar screen module, and therefore a major part of the small-sized particles to be separated does not pass through the screen apertures 2 until it reaches the top end of these, i.e. close by the discharge end B. This will affect the separating capacity and accuracy obtainable by a bar screen module.

In a bar screen module according to the present invention, the upper parts of the screen bars 1 are divided in the moving direction of the material into at least two parts 1a and 1b extending on different levels, whereby all upper surface parts 1a and 1b, respectively, of each level form, on the level in question, a stair step extending transversely to the moving direction of the material. In the embodiment shown in FIGS. 3 and 4, the upper part of the screen bar 1 is divided into two upper surface parts 1a and 1b on different levels. The screen bar 1 is either cast to one integrated element or it is manufactured from a separate web plate 3 and upper surface parts 1a, 1b carried by it.

The screen apertures 2 have the same size on both levels, i.e. at the outgoing end of each stair step they have their maximal size, and at their entering end they are about twice as large as the screen aperture of a conventional bar screen module. In this way, the screening area becomes larger, whereby separation of the material into an overgrained and an under-grained grain size group occurs more efficiently. In addition, the material to be fed is sorted once more when the material falls from the first stair step onto the next one, which also improves the separating capacity and accuracy.

The size of the grain to be separated is defined by the size of the screen apertures, whereby also the required difference between the levels of the stair steps is essentially defined by the size of the screen apertures. The required difference of the levels is essentially as large as the maximal size of the screen aperture.

Single screen bars are elastic, since they are attached on the frame of the bar screen module only at their entering ends. Therefore, the structure allows the free end of the screen bar to vibrate. Due to this, the screen apertures 2 can be formed into a more rectangular shape, without stones becoming jammed in the screen aperture.

The entering ends of adjacent upper surface parts 1b of each lower level are almost in contact with each other forming a transversally extending shelf 5 at the stair. Due to this shelf 5 the material to be fed, for instance a stone, can be prevented from becoming jammed in the screen aperture 2. When an oversized material piece, such as a stone, which has partly penetrated the screen aperture 2, bumps against this shelf 5, it will automatically roll out from the screen aperture 2 and fall onto the upper surface parts 1b of the lower level of the screen bars 1. When a material becomes jammed in the screen aperture 2, it naturally reduces the free surface area and thereby impairs the efficiency and the separating accuracy of the screening. In the worst case, a stone, or the like, which has become jammed in the screen aperture 2, can also damage the structure of the bar screen.

The very closely positioning of the entering ends of the upper surface parts 1b on the lower level of the bar screen module to each other prevents the single screen bars from bending sidewards at their entering end A. At the discharge end B of the bar screen module, there is a transverse support bar 4 supporting the screen bars, the upper edge of which is provided with a slot (not shown) at each screen bar 1, and in the shown embodiment at the web plate 3 thereof, to limit sideward movement of said screen bars. Also these slots prevent excessive sidewards bending of the screen bars at their discharge end B and thus the bar screen module from damaging.

The support bar 4 also prevents the screen bars from bending too much downwards allowing, however, the discharge end B of the screen bar to vibrate.

In a simplest embodiment, a single bar screen module is fixed only by four screws, and thus it can easily be replaced. The module must be replaceable, for instance due to a damage or a wear of the module, or when it is intended to change the grain size groups to be separated.

1. A bar screen module of a vibratory feeder, comprising screen bars (1) extending in moving direction of a material, and screen apertures (2) arranged between the screen bars to enlarge in the moving direction of the material, characterized in that the upper part of each screen bar (1) is divided in the moving direction of the material into at least two parts (1a, 1b) extending on different levels, whereby all upper surface parts (1a and 1b, respectively) on each level of the bar screen module form a stair step extending on the level in question transversely to the moving direction of the material.

2. The bar screen module according to claim 1, characterized in that the screen apertures (2) have same size on all stair steps and have a maximum width at the discharge end of each stair step.

3. The bar screen module according to claim 1, characterized in that the difference between the levels of the stair steps is small.

4. The bar screen module according to claim 1, characterized in that the single screen bars (1) are elastic and are attached only at the entering end (A) of the bar screen module.

5. The bar screen module according to claim 1, characterized in that the wedge-shape of the screen aperture (2) is very small, i.e. the screen aperture (2) is approximately rectangular.

6. The bar screen module according to claim 1, characterized in that the entering ends of the adjacent upper surface parts (1b) of each lower level are almost in contact with each other to form a transversely extending shelf (5).

7. The bar screen module according to claim 1, characterized in that at the discharge end (3) of the bar screen module there is a support bar (4) supporting the screen bars, the upper edge of which being provided with a slot at each screen bar (1) to limit sideward movement of said screen bars.

8. The bar screen module of any of the preceding claims 1 to 7, characterized in that each screen bar (1) consists of a web plate (3) and the upper surface parts (1a, 1b) carried by it.
